(19) United States
(12) Patent Application Publication
(10) Pub. No.: US 2012/0133661 A1
(43) Pub. Date: May 31, 2012

(54) DISPLAY DRIVING CIRCUIT AND DISPLAY DEVICE INCLUDING THE SAME

(75) Inventors: Sang-Kyu LEE, Suwon-si (KR); Hyun-Wook LIM, Seoul (KR)

(73) Assignee: SAMSUNG ELECTRONICS CO., LTD., Suwon-si (KR)

(21) Appl. No.: 13/306,752

(22) Filed: Nov. 29, 2011

(30) Foreign Application Priority Data
Nov. 30, 2010 (KR) 10-2010-0120121

(51) Int. Cl. G09G 5/36; G09G 5/00

(52) U.S. Cl. 345/558; 345/204

(57) ABSTRACT

A display driving circuit includes a clock dividing unit and a data processing unit. The clock dividing unit receives a first clock signal, generates a second clock signal having a second clock frequency by dividing the first clock signal having a first clock frequency, and outputs the second clock signal. The data processing unit receive the first clock signal, the second clock signal, and input data with a first data frequency, separates input data into first data and second data, outputs the first data based on the second clock signal, and outputs the second data with a second data frequency based on the first clock signal.

### CROSS-REFERENCE TO RELATED APPLICATION

This application claims priority from Korean Patent Application No. 10-2010-0120121, filed on Nov. 30, 2010 in the Korean Intellectual Property Office, the contents of which are herein incorporated by reference in their entirety.

### BACKGROUND

1. Field

Exemplary embodiments relate to a display device, and more particularly, to a display driving circuit and a display device including the display driving circuit.

2. Description of the Related Art

In general, a display device includes a display panel for displaying an image and a display driving circuit for driving the display panel. A display device may include a plurality of display driving circuits. For example, a display device may include a plurality of display panels and a plurality of display driving circuits each of which drives a respective one of the display panels. For another example, a display device may include a display panel and a plurality of display driving circuits each of which drives a portion of the display panel. As the number of the display driving circuits included in a display device increases, the number of data transmission channels for transmitting data from a host to the display driving circuits may increase.

### SUMMARY

One of more exemplary embodiments provide a display driving circuit capable of transmitting data through a single channel without including a phase locked loop (PLL).

One or more exemplary embodiments also provide a display device including the display driving circuit.

According to an aspect of an exemplary embodiment, there is provided a display driving circuit including a clock dividing unit and a data processing unit. The clock dividing unit receives a first clock signal, generates a second clock signal by dividing the first clock signal and outputs the second clock signal. The first clock signal has a first clock frequency and the second clock signal has a second clock frequency that is different than the first clock frequency. The data processing unit receives the first clock signal, the second clock signal, and input data with a first data frequency, separates input data into first data and second data, outputs the first data based on the second clock signal, and outputs the second data with a second data frequency based on the first clock signal.

The data processing unit may include a data distribution unit and a driving logic unit. The data distribution unit may separate the input data into the first data and the second data based on the first clock signal. The driving logic unit may output the first data based on the second clock signal, and may output the second data in synchronization with the first clock signal. The second data may be output with the second data frequency.

The driving logic unit may include a first buffer unit and a second buffer unit. The first buffer unit may store the first data, and may output the stored first data based on the second clock signal. The second buffer unit may store the second data, and may output the second data in synchronization with one of a rising edge and a falling edge of the first clock signal.

The second buffer unit may output the second data by a first-in-first-out (FIFO) method.

A ratio of the first clock frequency to the second clock frequency may be the same as a ratio of the first data frequency to the second data frequency.

The data processing unit may output the second data in synchronization with a rising edge of the first clock signal, and the clock dividing unit may output the second clock signal in synchronization with a falling edge of the first clock signal.

The data processing unit may output the second data in synchronization with an odd-numbered rising edge of the first clock signal, and the clock dividing unit may output the second clock signal in synchronization with an even-numbered rising edge of the first clock signal.

The data processing unit may output the second data in synchronization with a (3n−2)-th rising edge of the first clock signal, where n is a natural number, and the clock dividing unit may output the second clock signal in synchronization with a (3n−1)-th falling edge of the first clock signal.

The display driving circuit may further include a reception unit and a transmission unit. The reception unit may receive the first clock signal and the input data, provide the first clock signal to the clock dividing unit and the data processing unit, and may provide the input data to the data processing unit. The transmission unit may transmit the second clock signal and the second data.

The first clock signal and the input data may be received by a high speed serial interface (HSSI) method, and the second clock signal and the second data may be transmitted by the HSSI method.

The clock dividing unit may provide the second clock signal to an external circuit. The data processing unit may drive a display panel based on the first data and the second clock signal, and may provide the second data with the second data frequency to the external circuit based on the first clock signal.

According to other exemplary embodiments, a display device includes a display panel, a first display driving circuit and a second display driving circuit. The display panel includes a first area and a second area. The first display driving circuit receives a first clock signal and input data with a first data frequency, generates a second clock signal by dividing the first clock signal, and outputs the second clock signal, separates input data into first data and second data, drives the first area of the display panel based on the first data and the second clock signal, and outputs the second data with a second data frequency based on the first clock signal. The first clock signal has a first clock frequency and the second clock signal has a second clock frequency that is different than the first clock frequency. The second display driving circuit drives the second area of the display panel based on the second data and the second clock signal.

The first display driving circuit may include a first buffer unit and a second buffer unit. The first buffer unit may store the first data, and may provide the stored first data to the first area of the display panel based on the second clock signal. The second buffer unit may store the second data, and may provide the second data to the second display driving circuit in synchronization with the first clock signal.

The second display driving circuit may include a third buffer unit. The third buffer unit may store the second data, and may provide the stored second data to the second area of the display panel based on the second clock signal.

The first and second display driving circuits may drive the display panel after all of the first data is stored in the first buffer unit and all of the second data is stored in the third buffer unit.

The second display driving circuit may have a structure that is the same as a structure of the first display driving circuit.

According to still other exemplary embodiments, a display device includes a display, a first display driver and a second display driver. The display includes a first display panel and a second display panel. The first display driver receives a first clock and display data, frequency divides the first clock, without using feedback, to generate a second clock, separates the display data into first data and second data, drives the first display panel using the first data and the second clock, outputs, using the first clock, the second data with a different data frequency than the display data, and outputs the second clock. The second display driver receives the second data and the second clock, and drives the second display panel using the second data and the second clock.

The first display driver may frequency divide the clock by n to generate the second clock, and n is an integer.

The first display panel and the second display panel are different areas of the display.

The display data comprises image data or video data.

### BRIEF DESCRIPTION OF THE DRAWINGS

Illustrative, non-limiting exemplary embodiments will be more clearly understood from the following detailed description taken in conjunction with the accompanying drawings, in which:

FIG. 1 is a block diagram illustrating a display driving circuit according to some exemplary embodiments;

FIG. 2 is a block diagram illustrating an example of a data processing unit included in the display driving circuit of FIG. 1;

FIGS. 3, 4 and 5 are timing diagrams for describing operations of the display driving circuit of FIG. 1;

FIG. 6 is a block diagram illustrating a display driving circuit according to other exemplary embodiments;

FIG. 7 is a block diagram illustrating a display device according to some exemplary embodiments;

FIGS. 8, 9A, 9B, 9C, 9D and 9E are diagrams for describing operations of the display device of FIG. 7;

FIG. 10 is a block diagram illustrating a display device according to other exemplary embodiments;

FIG. 11 is a block diagram illustrating a display device according to still other exemplary embodiments;

FIG. 12 is a block diagram illustrating a display system including the display device according to some exemplary embodiments.

### DETAILED DESCRIPTION

Various exemplary embodiments will be described more fully with reference to the accompanying drawings, in which embodiments are shown. The inventive concept may, however, be embodied in many different forms and should not be construed as limited to the embodiments set forth herein. Rather, these exemplary embodiments are provided so that this disclosure will be thorough and complete, and will fully convey the scope of the inventive concept to those skilled in the art. Like reference numerals refer to like elements throughout this application.

It will be understood that, although the terms first, second, etc. may be used herein to describe various elements, these elements should not be limited by these terms. These terms are used to distinguish one element from another. For example, a first element could be termed a second element, and, similarly, a second element could be termed a first element, without departing from the scope of the inventive concept. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular exemplary embodiments and is not intended to be limiting of the inventive concept. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other.

The term “unit” as used herein means a hardware component and/or a software component that is executed by a hardware component such as a processor.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

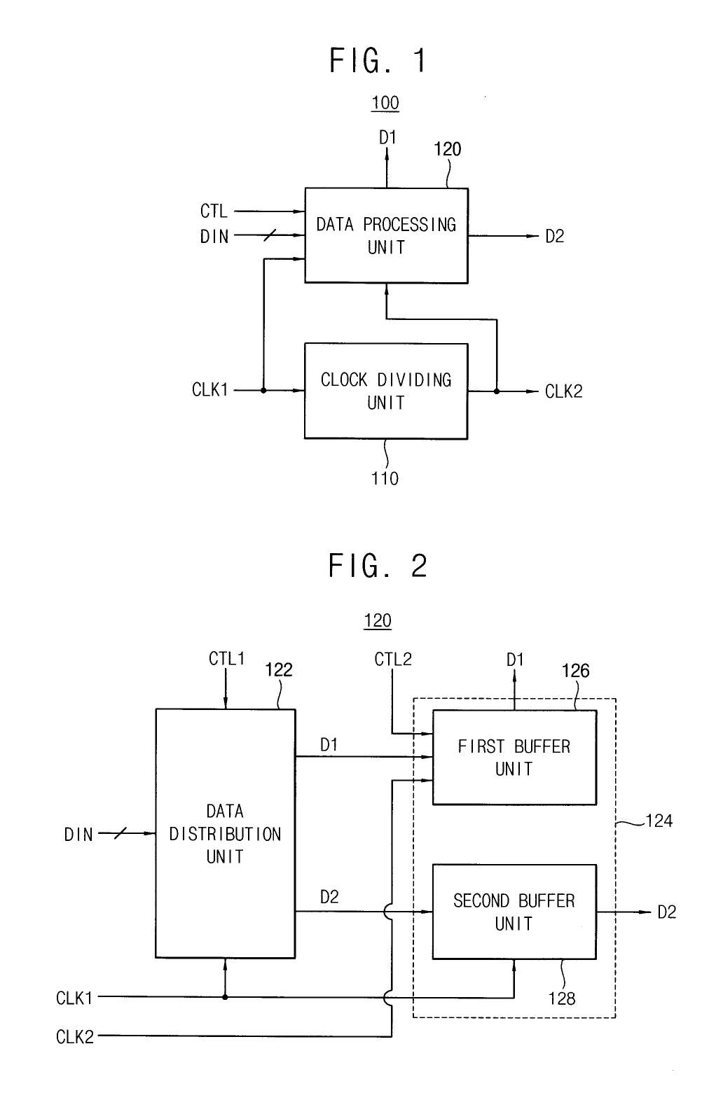

FIG. 1 is a block diagram illustrating a display driving circuit according to some exemplary embodiments.

Referring to FIG. 1, a display driving circuit 100 includes a clock dividing unit 110 and a data processing unit 120.

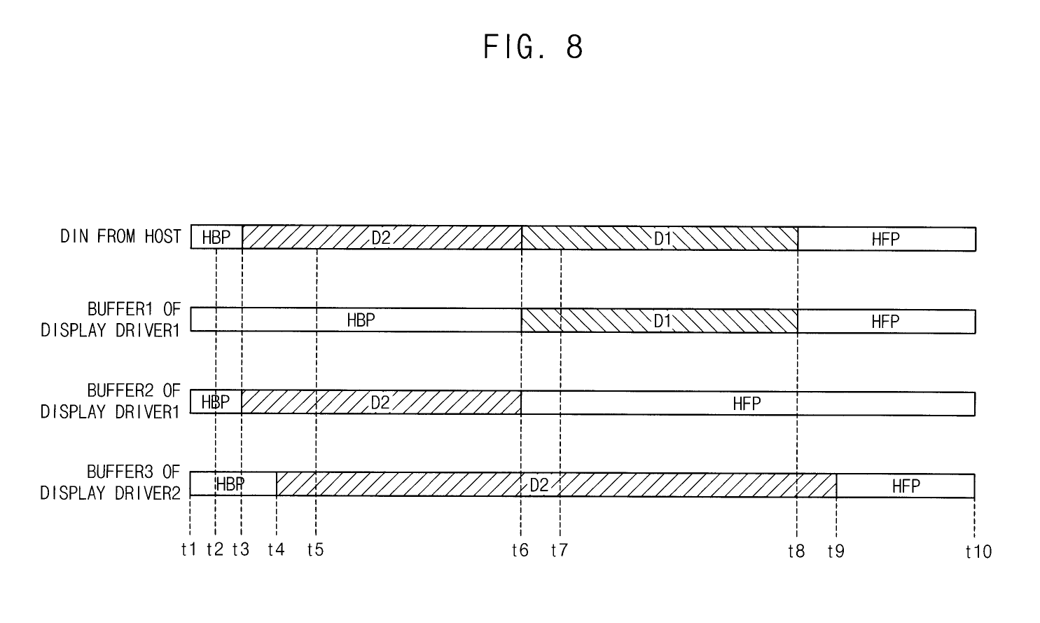

The display driving circuit 100 may be included in a display device. The display device may include a plurality of display driving circuits that are cascade-coupled, and may include a display panel or a plurality of display panels. When the display device includes a display panel, each of the display driving circuits may drive a portion of the display panel. When the display device includes a plurality of display panels, each of the display driving circuits may drive a respective one of the display panel. The display driving circuit 100 may be one of the plurality of display driving circuits. Detailed configurations of the display device will be described below with reference to FIGS. 7, 10 and 11.

The clock dividing unit 110 generates a second clock signal CLK2 by dividing a first clock signal CLK1. The second clock signal CLK2 may be provided to an external circuit (not illustrated). The first clock signal CLK1 has a first clock frequency and the second clock signal CLK2 has a second clock frequency that is different than the first clock frequency.

In an exemplary embodiment, the clock dividing unit 110 may receive the first clock signal CLK1 from a host (not illustrated) or a timing controller (not illustrated) that controls operations of the display device. In another exemplary embodiment, if the display device includes a plurality of display driving circuits that are cascade-coupled, the clock dividing unit 110 may receive the first clock signal CLK1 from a previous-stage display driving circuit. The external circuit may be a next-stage display driving circuit.

The data processing unit 120 receives input data DIN received with a first data frequency, and separates the input data DIN into first data D1 and second data D2. The first data D1 may be used in the display driving circuit 100 and the second data D2 may be used in the external circuit. The data processing unit 120 drives a display panel included in the display device based on the first data D1 and the second clock signal CLK2, and provides the second data D2 with a second data frequency to the external circuit based on the first clock signal CLK1. For example, the data processing unit 120 may output the second data D2 in synchronization with the first clock signal CLK1.

The first data frequency and the second data frequency may correspond to data rate of the input data DIN and the second data D2, respectively. For example, the first data frequency may correspond to data reception speed of the input data DIN, and the second data frequency may correspond to data transmission speed of the second data D2. The first data frequency may be substantially the same as the first clock frequency or may be higher than the first clock frequency. For example, when the display driving circuit 100 samples data in a double data rate (DDR) mode, the first data frequency may be twice as high as the first clock frequency.

The data processing unit 120 may receive the input data DIN from the host, the timing controller or the previous-stage display driving circuit. The input data DIN may be serialized and may be synchronized with the first clock signal CLK1. The first data D1 may be provided to the display panel corresponding to the display driving circuit 100, and the second data D2 may be provided to a display panel corresponding to the external circuit (e.g., the next-stage display driving circuit). For example, when the display device includes a single display panel, the first data D1 may be output to a first area of the display panel to drive the first area of the display panel, and the second data D2 may be output to a second area of the display panel to drive the second area of the display panel. When the display device includes a plurality of display panels (e.g., two display panels), the first data D1 may be output to a first display panel to drive the first display panel, and the second data D2 may be output to a second display panel to drive the second display panel. In an exemplary embodiment, the data processing unit 120 may receive the first data D1 after the second data D2 are received.

The data processing unit 120 may perform the above-described separating, driving and providing operations based on a control signal CTL. The data processing unit 120 may receive the control signal CTL from the host or the timing controller. The control signal CTL may include a horizontal synchronization signal, a vertical synchronization signal, an output enable signal, a switching signal, a charge sharing information signal, a polarity information signal, a line latch signal, etc.

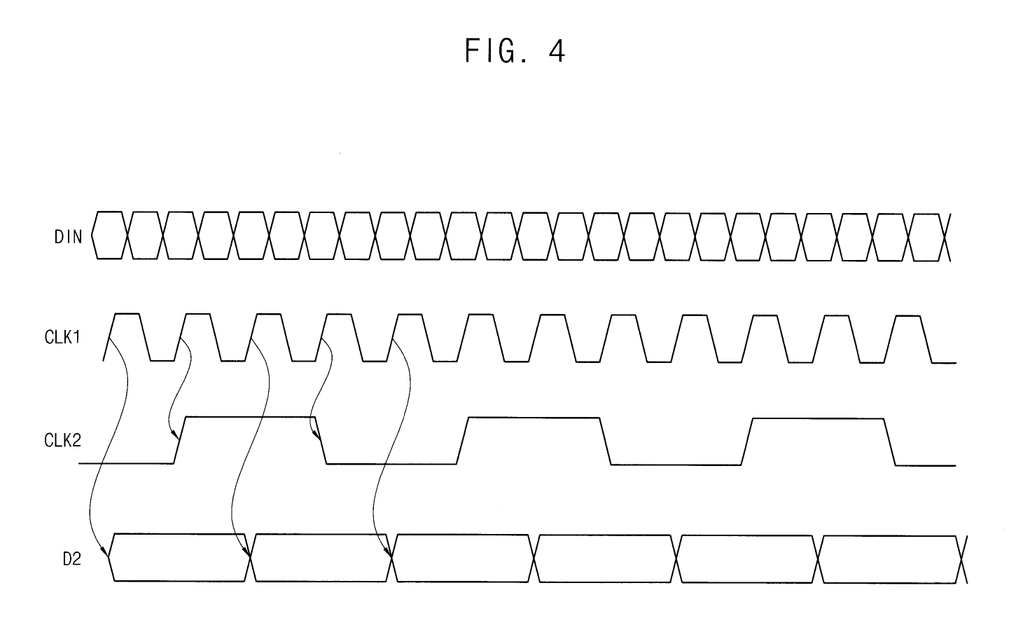

In an exemplary embodiment, a ratio of the first clock frequency to the second clock frequency is substantially the same as a ratio of the first data frequency to the second data frequency. For example, if the ratio of the first clock frequency to the second clock frequency is m:1, where m is a natural number equal to or greater than two, the ratio of the first data frequency to the second data frequency may be m:1. Detailed configurations of the clock frequencies and data frequencies will be described below with reference to FIGS. 3, 4 and 5.

In an exemplary embodiment, the first clock signal CLK1 and the input data DIN are received from the host by a high speed serial interface (HSSI) method. The second clock signal CLK2 and the second data D2 are transmitted to the external circuit (e.g., the next-stage display driving circuit) by the HSSI method.

In an exemplary embodiment, the display driving circuit 100 may be a source driver that drives a liquid crystal display (LCD) panel. In another exemplary embodiment, the display driving circuit 100 may be a driver that drives various display panels, such as a cathode ray tube (CRT) panel, a plasma display panel (PDP), a light emitting diode (LED) display panel, an organic LED (OLED) display panel, a field emission display (FED) panel, etc.

In a related art display device, as the number of display driving circuits for driving a display panel increases, the number of data transmission channels for transmitting data from a host to the display driving circuits increases. To decrease the number of data transmission channels, cascade-coupled display driving circuits are used in the related art display device. However, a related art display driving circuit included in the related art display device requires a phase locked loop (PLL) and/or a delay locked loop (DLL) for synchronizing a clock signal and/or data, and thus the related art display driving circuit has a relatively complex structure and relatively high power consumption.

In the display driving circuit 100 according to some exemplary embodiments, the clock dividing unit 110 generates the second clock signal CLK2 by dividing the first clock signal CLK1, and the data processing unit 120 provides the second data D2 to the external circuit based on the first clock signal CLK1. The frequency of the second clock signal CLK2 may be different from the frequency of the first clock signal CLK1, the data transmission speed of the second data D2 may be different from the data reception speed of the input data DIN, and both of the second clock signal CLK2 and the second data D2 may be synchronized with the first clock signal CLK1. Thus, the display driving circuit 100 does not require the PLL and/or the DLL, and may have a relatively simple structure and relatively low power consumption.

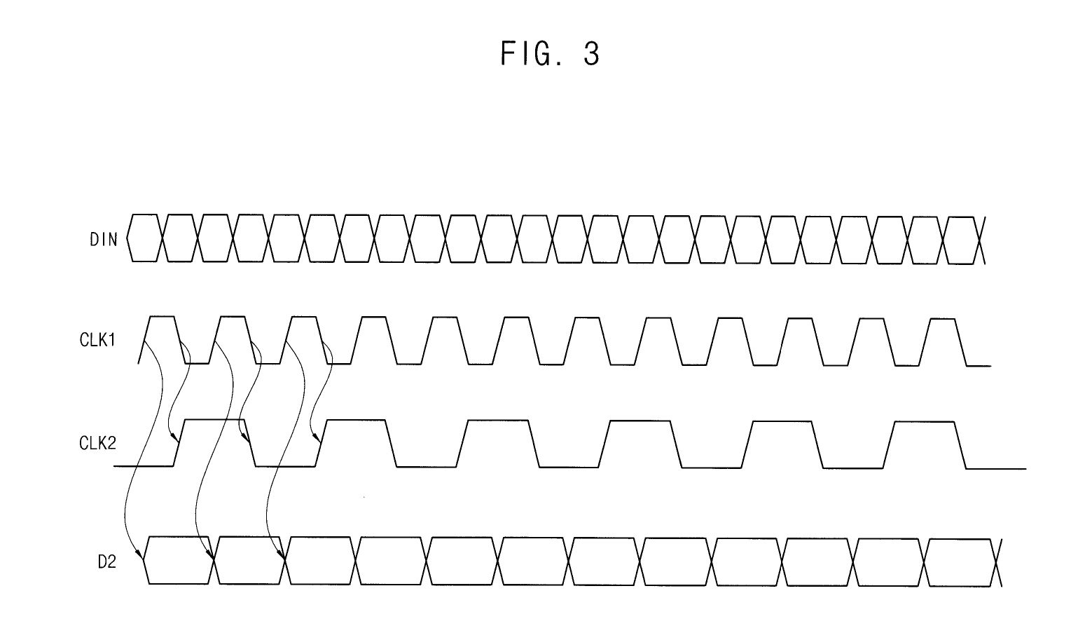

FIG. 2 is a block diagram illustrating an exemplary of a data processing unit included in the display driving circuit of FIG. 1.

Referring to FIG. 2, the data processing unit 120 may include a data distribution unit 122 and a driving logic unit 124.

The data distribution unit 122 may separate the input data DIN into the first data D1 and the second data D2 based on the first clock signal CLK1. For example, the data distribution unit 122 may separate the input data DIN depending on the number of pulses of the first clock signal CLK1, the number of the input data DIN, or channel information. The data distribution unit 122 may perform the separating operation based on a first control signal CTL1.

The driving logic unit 124 may drive the display panel based on the first data D1 and the second clock signal CLK2, and may provide the second data D2 to the external circuit in synchronization with the first clock signal CLK1. The second data D2 may be output with the second data frequency. The driving logic unit 124 may include a plurality of logic elements, and may include a first buffer unit 126 and a second buffer unit 128.

The first buffer unit 126 may store the first data D1, and may provide the stored first data D1 to the display panel based on the second clock signal CLK2. The first buffer unit 126 may perform such storing and providing operations based on a second control signal CTL2. For example, lines and frames in the display panel may be synchronized based on the second clock signal CLK2 and the second control signal CTL2 (e.g., the horizontal and vertical synchronization signals), pixel information for the display panel may be obtained from the first data D1, and an image corresponding to the first data D1 may be displayed in the display panel based on the pixel information.

The second buffer unit 128 may store the second data D2, and may provide the second data D2 to the external circuit in synchronization with one of a rising edge and a falling edge of the first clock signal CLK1. The second data D2 may be output with the second data frequency. In an exemplary embodiment, the second buffer unit 128 may be operated by a first-in-first-out (FIFO) method. For example, the second buffer unit 128 may sequentially output the second data D2 in order of data received.

In an exemplary embodiment, the input data DIN and the second data D2 may be transmitted by a single-pair scheme or a multi-pair scheme. The single-pair scheme may indicate that data are transmitted as a pair of differential signals, and the multi-pair scheme may indicate that data are transmitter as at least two pairs of differential signals. For example, if data transmission speed is relatively slow, the input data DIN and the second data D2 may be transmitted by the single-pair scheme. If data transmission speed is relatively fast, the input data DIN and the second data D2 may be transmitted by the multi-pair scheme.

FIGS. 3, 4 and 5 are exemplary timing diagrams for describing operations of the display driving circuit of FIG. 1.

FIGS. 3, 4 and 5 illustrate operations of the display driving circuit 100 of FIG. 1 according to a division ratio of the first clock signal CLK1 to the second clock signal CLK2. In FIGS. 3, 4 and 5, the display driving circuit 100 may sample the input data DIN at rising edges and/or falling edges of the first clock signal CLK1.

Hereinafter, operations of the display driving circuit 100 will be described with reference to FIGS. 1 through 5.

Referring to FIGS. 1, 2 and 3, a first ratio of the first clock frequency to the second clock frequency may be the same as a second ratio of the first data frequency to the second data frequency. For example, each of the first ratio and the second ratio may be 2:1.

The clock dividing unit 110 generates the second clock signal CLK2 by dividing the first clock signal CLK1 to provide the second clock signal CLK2 to the external circuit in synchronization with the first clock signal CLK1. For example, the clock dividing unit 110 may output the second clock signal CLK2 in synchronization with a falling edge of the first clock signal CLK1. The first clock frequency of the first clock signal CLK1 is two times higher than the second clock frequency of the second clock signal CLK2.

The second buffer unit 128 included in the data processing unit 120 stores the second data D2, and provides the second data D2 to the external circuit in synchronization with the first clock signal CLK1. For example, the second buffer unit 128 may output the second data D2 in synchronization with a rising edge of the first clock signal CLK1. The first data frequency of the input data DIN is two times higher than the second data frequency of the second data D2.

Although the second clock signal CLK2 synchronized with the falling edge of the first clock signal CLK1 and the second data D2 synchronized with the rising edge of the first clock signal CLK1 are illustrated in FIG. 3, the second clock signal CLK2 may be synchronized with the rising edge of the first clock signal CLK1 and the second data D2 may be synchronized with the falling edge of the first clock signal CLK1, according to some exemplary embodiments.

Referring to FIGS. 1, 2 and 4, the first ratio of the first clock frequency to the second clock frequency may be the same as the second ratio of the first data frequency to the second data frequency. For example, each of the first ratio and the second ratio may be 4:1.

The clock dividing unit 110 generates the second clock signal CLK2 by dividing the first clock signal CLK1 to provide the second clock signal CLK2 to the external circuit in synchronization with the first clock signal CLK1. For example, the clock dividing unit 110 may output the second clock signal CLK2 in synchronization with an even-numbered rising edge of the first clock signal CLK1. In this case, the first clock frequency of the first clock signal CLK1 is four times higher than the second clock frequency of the second clock signal CLK2.

The second buffer unit 128 included in the data processing unit 120 stores the second data D2, and provides the second data D2 to the external circuit in synchronization with the first clock signal CLK1. For example, the second buffer unit 128 may output the second data D2 in synchronization with an odd-numbered rising edge of the first clock signal CLK1. The first data frequency of the input data DIN is four times higher than the second data frequency of the second data D2.

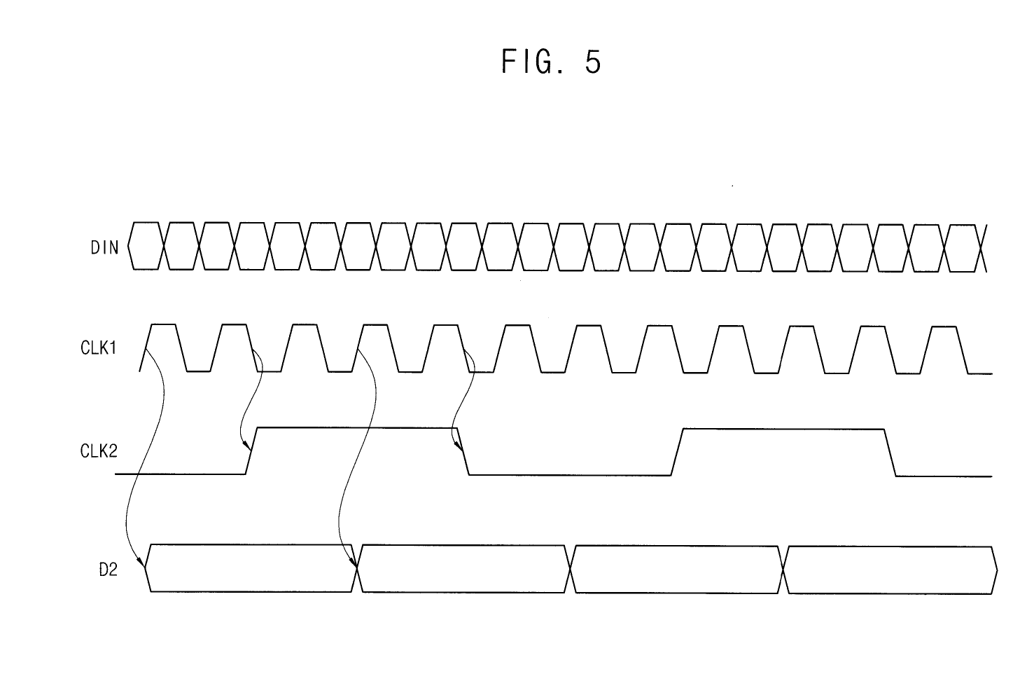

Although the second clock signal CLK2 synchronized with the even-numbered rising edge of the first clock signal CLK1 and the second data D2 synchronized with the odd-numbered rising edge of the first clock signal CLK1 are illustrated in FIG. 4, the second clock signal CLK2 may be synchronized with the odd-numbered rising edge of the first clock signal CLK1 and the second data D2 may be synchronized with the even-numbered rising edge of the first clock signal CLK1, according to some exemplary embodiments. In the other exemplary embodiments, each of the second clock signal CLK2 and the second data D2 may be synchronized with the falling edge of the first clock signal CLK1.

Referring to FIGS. 1, 2 and 5, the first ratio of the first clock frequency to the second clock frequency may be the same as the second ratio of the first data frequency to the second data frequency. For example, each of the first ratio and the second ratio may be 6:1.

The clock dividing unit 110 generates the second clock signal CLK2 by dividing the first clock signal CLK1 to provide the second clock signal CLK2 to the external circuit in synchronization with the first clock signal CLK1. For example, the clock dividing unit 110 may output the second clock signal CLK2 in synchronization with a (3n−2)-th rising edge of the first clock signal CLK1, where n is a natural number. In this case, the first clock frequency of the first clock signal CLK1 is six times higher than the second clock frequency of the second clock signal CLK2.

The second buffer unit 128 included in the data processing unit 120 stores the second data D2, and provides the second data D2 to the external circuit in synchronization with the first clock signal CLK1. For example, the second buffer unit 128 may output the second data D2 in synchronization with a (3n−1)-th falling edge of the first clock signal CLK1. The first data frequency of the input data DIN is six times higher than the second data frequency of the second data D2.

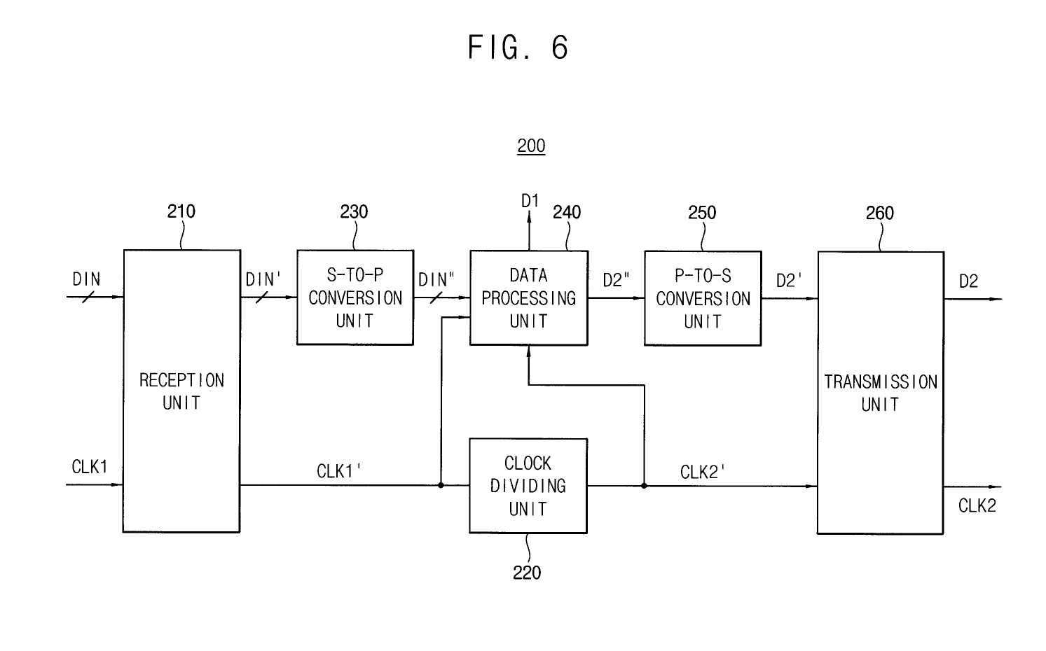

Although the second clock signal CLK2 synchronized with the (3n−2)-th rising edge of the first clock signal CLK1 and the second data D2 synchronized with the (3n−1)-th falling edge of the first clock signal CLK1 are illustrated in FIG. 5, the second clock signal CLK2 may be synchronized with the (3n−2)-th falling edge of the first clock signal CLK1 and the second data D2 may be synchronized with the (3n−1)-th rising edge of the first clock signal CLK1, according to some exemplary embodiments. Although FIGS. 3, 4 and 5 represent the display driving circuit 100 that is implemented with the first and second ratios having a value of 2:1, 4:1 and 6:1, respectively, the value of the first and second ratios are not limited thereto.

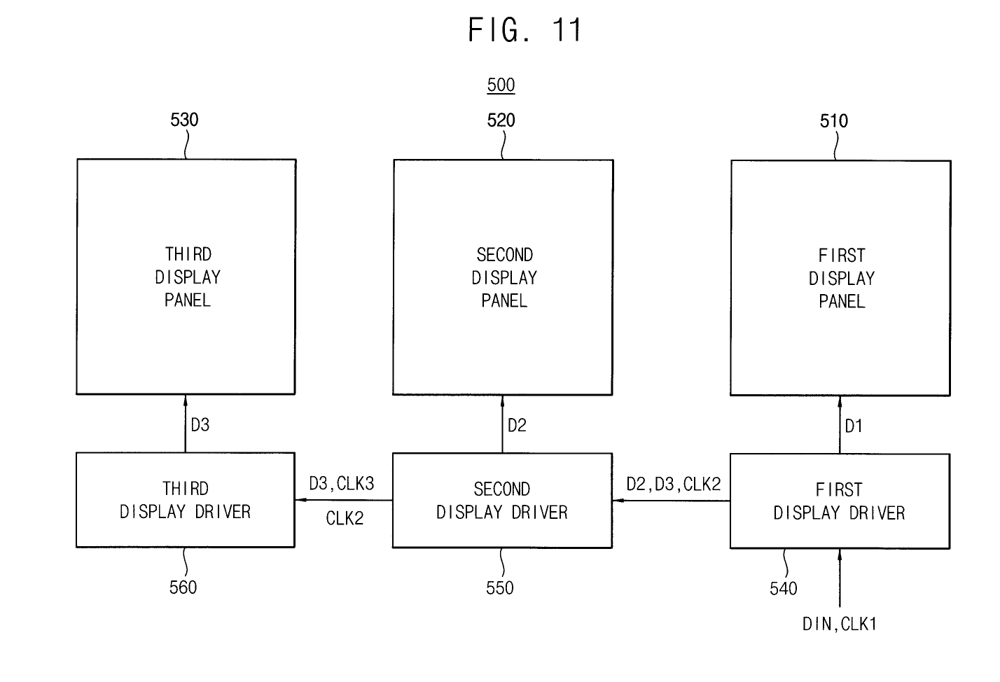

In an exemplary embodiment, the input data received from the host may include at least three different types of data. In this case, the display driving circuit according to some exemplary embodiments may be employed in a display device that includes a single display device having at least three areas or includes at least three display panels. For example, if the input data includes first data, second data and third data, the data distribution unit may separate the input data into the first data, the second data and the third data based on the first clock signal. The driving logic unit may drive the display panel based on the first data and the second clock signal, and may provide the second data and the third data to the external circuit in synchronization with the first clock signal. The driving logic unit may include a first buffer unit storing the first data and a second buffer unit storing the second and third data, or may include a first buffer unit storing the first data, a second buffer unit storing the second data and a third buffer unit storing the third data, according to some exemplary embodiments. Detailed operations of the display driving circuit will be described later with reference to FIG. 11.

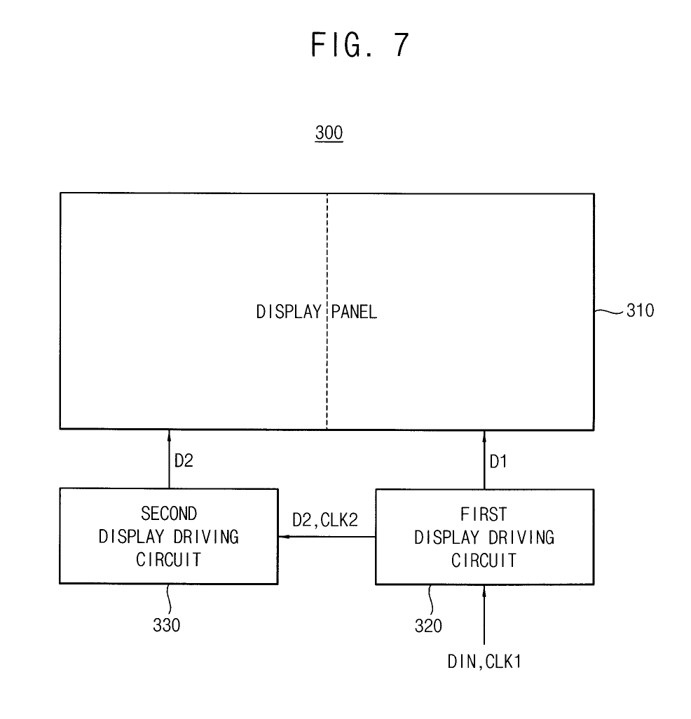

FIG. 6 is a block diagram illustrating a display driving circuit according to other exemplary embodiments.

Referring to FIG. 6, a display driving circuit 200 includes a reception unit 210, a clock dividing unit 220, a serial-to-parallel (S-to-P) conversion unit 230, a data processing unit 240, a parallel-to-serial (P-to-S) conversion unit 250 and a transmission unit 260.

The reception unit 210 receives a first clock signal CLK1 having a first clock frequency and provides a first internal clock signal CLK1′ to the clock dividing unit 220 and the data processing unit 240. The reception unit 210 receives input data DIN received with a first data frequency and provides internal input data DIN′ to the serial-to-parallel conversion unit 230. The first internal clock signal CLK1′ may be substantially the same as the first clock signal CLK1, and the internal input data DIN′ may be substantially the same as the input data DIN. The first clock signal CLK1 and the input data DIN may be received from a host (not illustrated) or a timing controller (not illustrated) by the HSSI method.

The serial-to-parallel conversion unit 230 generates parallelized input data DIN″ based on the internal input data DIN′. The parallelized input data DIN″ may be substantially the same as the input data DIN.

The clock dividing unit 220 generates a second internal clock signal CLK2′ by dividing the first internal clock signal CLK1′ to output the second internal clock signal CLK2′ in synchronization with the first internal clock signal CLK1′.

The data processing unit 240 separates the parallelized input data DIN″ into first data D1 and parallelized data D2″, drives a display panel included in a display device based on the first data D1 and the second internal clock signal CLK2′, and outputs the parallelized data D2″ in synchronization with the first internal clock signal CLK1′. The clock dividing unit 220 and the data processing unit 240 may be substantially the same as the clock dividing unit 110 and the data processing unit 120 in FIG. 1, respectively.

The parallel-to-serial conversion unit 250 generates serialized data D2′ based on the parallelized data D2″. The serialized data D2′ may be substantially the same as the parallelized data D2″.

The transmission unit 260 generates and transmits a second clock signal CLK2 having a second clock frequency and second data D2 with a second data frequency to an external device (not illustrated). The second clock signal CLK2 may be substantially the same as the second internal clock signal CLK2′, and the second data D2 may be substantially the same as the parallelized data D2″. The second clock signal CLK2 and the second data D2 may be transmitted to an external device (e.g., a next-stage display driving circuit) by the HSSI method.

In an exemplary embodiment, the serial-to-parallel conversion unit 230, the data processing unit 240 and the parallel-to-serial conversion unit 250 may operate based on a control signal (not illustrated).

FIG. 7 is a block diagram illustrating a display device according to some exemplary embodiments.

Referring to FIG. 7, a display device 300 includes a display panel 310, a first display driving circuit 320 and a second display driving circuit 330.

The display panel 310 includes a first area (e.g., a right half of the display panel) and a second area (e.g., a left half of the display panel). The first area may be driven by the first display driving circuit 320, and the second area may be driven by the second display driving circuit 330. In an exemplary embodiment, the display panel 310 may be one of an LCD panel, a CRT panel, a PDP, an LED display panel, an OLED display panel, or an FED panel, etc.

The first display driving circuit 320 receives a first clock signal CLK1 having a first clock frequency and input data DIN received with a first data frequency. The first display driving circuit 320 generates a second clock signal CLK2 having a second clock frequency by dividing the first clock signal CLK1. The first display driving circuit 320 separates the input data DIN into first data D1 and second data D2, drives the first area of the display panel 310 based on the first data D1 and the second clock signal CLK2, and outputs the second data D2 with a second data frequency in synchronization with the first clock signal CLK1.

The first display driving circuit 320 may be the display driving circuit 100 of FIG. 1. For example, the first display driving circuit 320 may include a clock dividing unit for performing the dividing operation and a data processing unit for performing the separating, driving and outputting operations. The data processing unit may be the data processing unit 120 of FIG. 2. For example, the data processing unit may include a data distribution unit for performing the separating operation and a driving logic unit for performing the driving and outputting operations. The driving logic unit may include a first buffer unit and a second buffer unit.

The first buffer unit may store the first data D1, and may provide the stored first data D1 to the first area of the display panel 310 based on the second clock signal CLK2. The second buffer unit may store the second data D2, and may provide the second data D2 to the second display driving circuit 330 in synchronization with the first clock signal CLK1.

The second display driving circuit 330 drives the second area of the display panel 310 based on the second data D2 and the second clock signal CLK2. For example, the second display driving circuit 330 may include a third buffer unit. The third buffer unit may store the second data D2, and may provide the stored second data D2 to the second area of the display panel 310 based on the second clock signal CLK2.

In an exemplary embodiment, the second display driving circuit 330 may have a structure that is substantially the same as a structure of the first display driving circuit 320. In another exemplary embodiment, the second display driving circuit 330 may include only the third buffer unit.

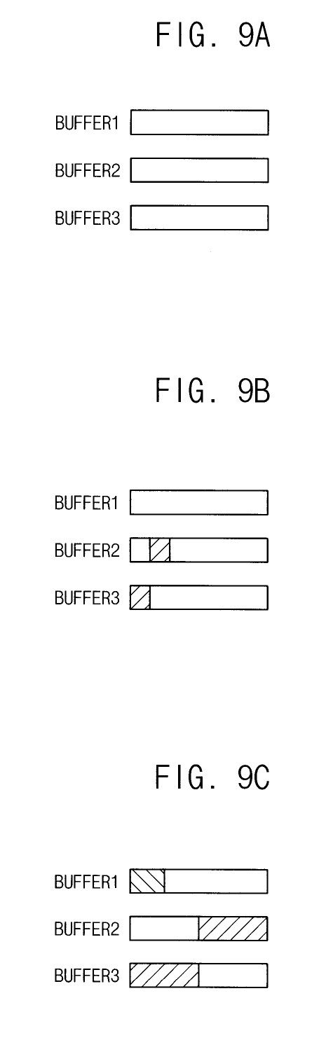

In an exemplary embodiment, the first and second display driving circuits 320 and 330 may drive the display panel 310 after all of the first data D1 are stored in the first buffer unit and all of the second data D2 are stored in the third buffer unit, as will be described below with reference to FIG. 8. That is, the first and the second areas of the display panel 310 may be simultaneously driven by the first and second display driving circuits 320 and 330.

Although the display device using the second clock signal CLK2 as a display driving clock is illustrated in FIG. 7, the display device may use the first clock signal CLK1 as the display driving clock depending on a resolution of the display panel. For example, the first display driving circuit may drive the first area of the display panel based on the first data and the first clock signal, and the second display driving circuit may drive the second area of the display panel based on the second data and the first clock signal.

The display device 300 according to some exemplary embodiments includes the first and second display driving circuits 320 and 330 that are cascade-coupled and transmit data through a single data transmission channel. The first display driving circuit 320 receives the first clock signal CLK1 having the first clock frequency and the input data DIN received with the first data frequency. The first display driving circuit 320 drives the first area of the display panel 310 based on the first data D1 and the second clock signal CLK2. The second display driving circuit 330 drives the second area of the display panel 310 based on the second data D2 and the second clock signal CLK2. The second clock signal CLK2 has the second clock frequency, the second data D2 are transmitted with the second data frequency, and the second clock signal CLK2 and the second data D2 are synchronized with the first clock signal CLK1, respectively. Thus, the display driving circuits 320 and 330 do not require a PLL and/or a DLL, and the display device 300 may have a relatively simple structure and relatively low power consumption.

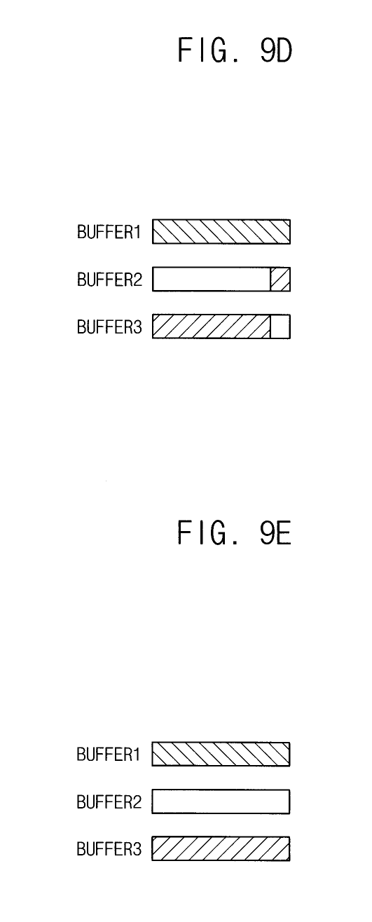

FIGS. 8, 9A, 9B, 9C, 9D and 9E are diagrams for describing operations of the display device of FIG. 7.

FIG. 8 illustrates operations of the display device during a 1 H time interval, where the ‘1 H time’ interval denotes a time period for processing a single horizontal line of the display panel 310. FIGS. 9A, 9B, 9C, 9D and 9E illustrate states of the first, second and third buffer units at times t2, t5, t7, t8 and t9, respectively.

In FIG. 8, the ratio of the first data frequency to the second data frequency may be 2:1, as described above with reference to FIG. 3. In FIG. 8, horizontal back porch (HBP) and horizontal front porch (HFP) denote time periods for awaiting data reception. In FIGS. 8, 9A, 9B, 9C, 9D and 9E, BUFFER1, BUFFER2 and BUFFER3 denote a state of the first buffer unit in the first display driving circuit 320, a state of the second buffer unit in the first display driving circuit 320 and a state of the third buffer unit in the second display driving circuit 330, respectively.

Hereinafter, operations of the display device 300 will be described with reference to FIGS. 7, 8, 9A, 9B, 9C, 9D and 9E.

During a time period from time t1 to time t3, the first display driving circuit 320 awaits reception of the input data DIN including the first data D1 and the second data D2. The input data DIN are not received from the host, the first display driving circuit 320 is ready to receive the input data DIN. For example, the first, second and third buffer units are empty at time t2, as illustrated in FIG. 9A.

At time t3, the first display driving circuit 320 starts to receive the input data DIN (that is, the second data D2) with the first data frequency from the host. The input data DIN are synchronized with the first clock signal CLK1. As described above, the second data D2 for driving the second area of the display panel 310 may be received prior to the first data D1 for driving the first area of the display panel 310. The second data D2 are stored in the second buffer unit.

At time t4, the first display driving circuit 320 starts to output the second data D2 in synchronization with the first clock signal CLK1. The second data D2 are provided to the second display driving circuit 330 with the second data frequency, and are stored in the third buffer unit. As described above with reference to FIG. 3, a first data transmission speed of the second data D2 from the host to the first display driving circuit 320 is two times faster than a second data transmission speed of the second data D2 from the first display driving circuit 320 to the second display driving circuit 330. For example, at time t5, a half of the second data D2 stored in the second buffer unit may be transmitted to the third buffer unit, as illustrated in FIG. 9B. The second data D2 in the second buffer unit may be transmitted by the FIFO method. The transmitted second data D2 in the second buffer unit may be erased.

At time t6, the first display driving circuit 320 starts to receive the first data D1 with the first data frequency from the host. The first data D1 are stored in the first buffer unit. The second data D2 stored in the second buffer unit are still provided to the third buffer with the second data frequency. For example, at time t7, the first data D1 may be stored in the first buffer unit, and a half of the second data D2 stored in the second buffer unit may be transmitted to the third buffer unit, as illustrated in FIG. 9C.

At time t8, a first transmitting operation from the host to the first display driving circuit 320 is completed, and all of the first data D1 are stored in the first buffer unit, as illustrated in FIG. 9D. At time t9, a second transmitting operation from the first display driving circuit 320 to the second display driving circuit 330 is completed, and all of the second data D2 are stored in the third buffer unit, as illustrated in FIG. 9E.

As described above, the first and second display driving circuits 320 and 330 may drive the display panel 310 after all of the first data D1 are stored in the first buffer unit and all of the second data D2 are stored in the third buffer unit. For example, during a time period from time t9 to time t10, the display panel 310 may be driven by the first and second display driving circuits 320 and 330, and the display device 300 may display an image corresponding to the input data DIN (i.e., the first and second data D1 and D2). The first display driving circuit 320 may provide the first data D1 to the first area of the display panel 310 based on the second clock signal CLK2, and the second display driving circuit 330 may provide the second data D2 to the second area of the display panel 310 based on the second clock signal CLK2.

Although the display device 300 including two display driving circuits 320 and 330 is illustrated in FIG. 7, the display device according to some exemplary embodiments may include at least three display driving circuits that are cascaded-coupled, and the display panel 310 may be driven by the at least three display driving circuits.

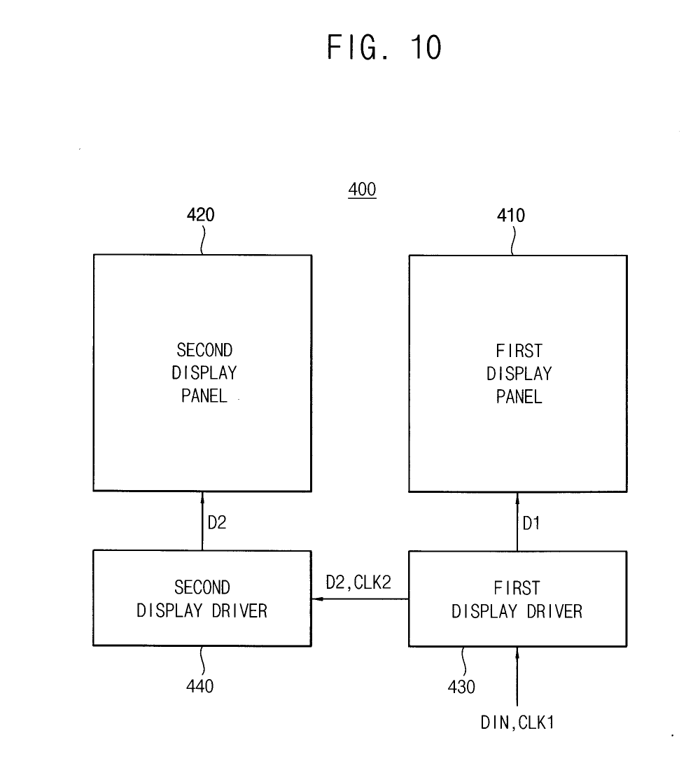

FIG. 10 is a block diagram illustrating a display device according to other exemplary embodiments.

Referring to FIG. 10, a display device 400 includes a first display panel 410, a second display panel 420, a first display driving circuit 430 and a second display driving circuit 440.

The first display panel 410 may be driven by the first display driving circuit 430, and the second display panel 420 may be driven by the second display driving circuit 440. In an exemplary embodiment, the first and second display panels 410 and 420 may be one of an LCD panel, a CRT panel, a PDP, an LED display panel, an OLED display panel, or an FED panel, etc., respectively.

The first display driving circuit 430 receives a first clock signal CLK1 having a first clock frequency and input data DIN received with a first data frequency. The first display driving circuit 430 generates a second clock signal CLK2 having a second clock frequency by dividing the first clock signal CLK1. The first display driving circuit 430 separates the input data DIN into first data D1 and second data D2, drives the first display panel 410 based on the first data D1 and the second clock signal CLK2, and outputs the second data D2 with a second data frequency in synchronization with the first clock signal CLK1. The second display driving circuit 440 drives the second display panel 420 based on the second data D2 and the second clock signal CLK2.

The first display driving circuit 430 and the second display driving circuit 440 may be substantially the same as the first display driving circuit 320 and the second display driving circuit 330 in FIG. 7, respectively.

FIG. 11 is a block diagram illustrating a display device according to still other exemplary embodiments.

Referring to FIG. 11, a display device 500 includes a first display panel 510, a second display panel 520, a third display panel 530, a first display driving circuit 540, a second display driving circuit 550 and a third display driving circuit 560.

The first display panel 510 may be driven by the first display driving circuit 540, the second display panel 520 may be driven by the second display driving circuit 550, and the third display panel 540 may be driven by the third display driving circuit 560. In an exemplary embodiment, the first, second and third display panels 510, 520 and 530 may be one of an LCD panel, a CRT panel, a PDP, an LED display panel, an OLED display panel, or an FED panel, etc., respectively.

The first display driving circuit 540 receives a first clock signal CLK1 having a first clock frequency and input data DIN received with a first data frequency. The first display driving circuit 540 generates a second clock signal CLK2 having a second clock frequency by dividing the first clock signal CLK1. The first display driving circuit 540 separates the input data DIN into first data D1, second data D2 and third data D3, drives the first display panel 510 based on the first data D1 and the second clock signal CLK2, and outputs the second data D2 and the third data D3 with a second data frequency in synchronization with the first clock signal CLK1.

In an exemplary embodiment, the first display driving circuit 540 may be the display driving circuit 100 of FIG. 1. For example, the first display driving circuit 540 may include a first buffer unit storing the first data D1 and a second buffer unit storing the second data D2 and the third data D3. In another exemplary embodiment, the first display driving circuit 540 may include three buffer units each of which stores a respective one of the first, second and third data D1, D2 and D3.

The second display driving circuit 550 receives the second clock signal CLK2 having the second clock frequency and the second and third data D2 and D3 received with the second data frequency. The second display driving circuit 550 generates a third clock signal CLK3 having a third clock frequency by dividing the second clock signal CLK2. The second display driving circuit 550 separates the data output from the first display driving circuit 540 into the second data D2 and the third data D3, drives the second display panel 520 based on the second data D2, the second clock signal CLK2 and the third clock signal CLK3, and outputs the third data D3 with a third data frequency in synchronization with the second clock signal CLK2.

In an exemplary embodiment, the second display driving circuit 550 may be the display driving circuit 100 of FIG. 1. For example, the second display driving circuit 550 may include a clock dividing unit and a data processing unit. The data processing unit may be the data processing unit 120 of FIG. 2. For example, the data processing unit may include a data distribution unit and a driving logic unit. The driving logic unit may include a third buffer unit storing the second data D2 and a fourth buffer unit storing the third data D3.

The third display driving circuit 560 drives the third display panel 530 based on the third data D3, the second clock signal CLK2 and the third clock signal CLK3. In an exemplary embodiment, the third display driving circuit 560 may be the display driving circuit 100 of FIG. 1. In another exemplary embodiment, the third display driving circuit 560 may include only a single buffer unit for storing the third data D3.

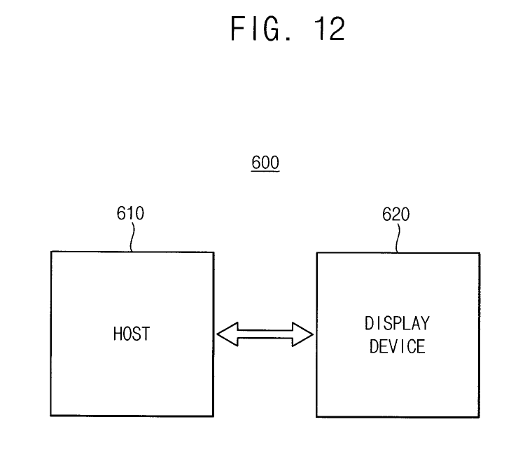

FIG. 12 is a block diagram illustrating a display system including the display device according to some exemplary embodiments.

Referring to FIG. 12, a display system 600 includes a host 610 and a display device 620.

The host 610 provides data and a clock signal to the display device 620 to control operations of the display device 620. The host 610 may include a processor for performing calculations or computing functions for various tasks, and a PLL and/or a DLL for synchronizing the clock signal. For example, the processor may be a microprocessor or a central processing unit (CPU). The data and the clock signal may be provided by a HSSI method.

The display device 620 displays an image based on the data and the clock signal. The display device 620 may be one of the display device 300 of FIG. 7, the display device 400 of FIG. 10 and the display device 500 of FIG. 11. For example, the display device 620 may include at least one display panel and a plurality of display driving circuit that are cascade-coupled and drive the at least one display panel. Each display driving circuit may be the display driving circuit 100 of FIG. 1.

The above described exemplary embodiments may be applied to any system having a display device. Thus, the present inventive concept may be applied to a system, such as a desktop computer, a laptop computer, a digital camera, a video camcorder, a cellular phone, a smart phone, a portable multimedia player (PMP), a personal digital assistant (PDA), an MP3 player, a digital television, a solid state drive (SSD), a navigation device, etc.

The foregoing is illustrative of exemplary embodiments and is not to be construed as limiting thereof. Although a few exemplary embodiments have been described, those skilled in the art will readily appreciate that many modifications are possible in the exemplary embodiments without materially departing from the novel teachings and advantages of the present inventive concept. Accordingly, all such modifications are intended to be included within the scope of the present inventive concept as defined in the claims. Therefore, it is to be understood that the foregoing is illustrative of various exemplary embodiments and is not to be construed as limited to the specific exemplary embodiments disclosed, and that modifications to the disclosed exemplary embodiments, as well as other exemplary embodiments, are intended to be included within the scope of the appended claims.

What is claimed is:

1. A display driving circuit comprising:
a clock dividing unit configured to receive a first clock signal, generate a second clock signal by dividing the first clock signal, and output the second clock signal, the first clock signal having a first clock frequency and the second clock signal having a second clock frequency that is different than the first clock frequency; and
a data processing unit configured to receive the first clock signal, the second clock signal, and input data with a first data frequency, separate the input data into first data and second data, output the first data based on the second clock signal, and output the second data with a second data frequency based on the first clock signal.

2. The display driving circuit of claim 1, wherein the data processing unit comprises:
a data distribution unit configured to separate the input data into the first data and the second data based on the first clock signal; and
a driving logic unit configured output the first data based on the second clock signal, and output the second data in synchronization with the first clock signal, the second data being output with the second data frequency.

3. The display driving circuit of claim 2, wherein the driving logic unit comprises:
a first buffer unit configured to store the first data, and output the stored first data based on the second clock signal; and
a second buffer unit configured to store the second data, and output the second data in synchronization with one of a rising edge and a falling edge of the first clock signal.

4. The display driving circuit of claim 3, wherein the second buffer unit is configured to output the second data by a first-in-first-out method.

5. The display driving circuit of claim 1, wherein a ratio of the first clock frequency to the second clock frequency is the same as a ratio of the first data frequency to the second data frequency.

6. The display driving circuit of claim 5, wherein the data processing unit outputs the second data in synchronization with a rising edge of the first clock signal, and the clock dividing unit outputs the second clock signal in synchronization with a falling edge of the first clock signal.

7. The display driving circuit of claim 5, wherein the data processing unit outputs the second data in synchronization with an odd-numbered rising edge of the first clock signal, and the clock dividing unit outputs the second clock signal in synchronization with an even-numbered rising edge of the first clock signal.

8. The display driving circuit of claim 5, wherein the data processing unit outputs the second data in synchronization with a (3n−2)-th rising edge of the first clock signal, the clock dividing unit outputs the second clock signal in synchronization with a (3n−1)-th falling edge of the first clock signal, and n is a natural number.

9. The display driving circuit of claim 1, further comprising:
a reception unit configured to receive the first clock signal and the input data, provide the first clock signal to the clock dividing unit and the data processing unit, and provide the input data to the data processing unit; and
a transmission unit configured to transmit the second clock signal and the second data.

10. The display driving circuit of claim 1, wherein the first clock signal and the input data are received by a high speed serial interface method, and the second clock signal and the second data are transmitted by the HSSI method.

11. The display driving circuit of claim 1, wherein the clock dividing unit provides the second clock signal to an external circuit, and
the data processing unit drives a display panel based on the first data and the second clock signal, and provides the second data with the second data frequency to the external circuit based on the first clock signal.

12. A display device comprising:
a display panel comprising a first area and a second area;
a first display driving circuit configured to receive a first clock signal and input data with a first data frequency, generate a second clock signal by dividing the first clock signal, output the second clock signal, separate the input data into first data and second data, drive the first area of the display panel based on the first data and the second clock signal, and output the second data with a second data frequency based on the first clock signal, the first clock signal having a first clock frequency and the second clock signal having a second clock frequency that is different than the first clock frequency; and
a second display driving circuit configured to drive the second area of the display panel based on the second data and the second clock signal.

13. The display device of claim 12, wherein the first display driving circuit comprises:
a first buffer unit configured to store the first data, and provide the stored first data to the first area of the display panel based on the second clock signal; and
a second buffer unit configured to store the second data, and provide the second data to the second display driving circuit in synchronization with the first clock signal.

14. The display device of claim 13, wherein the second display driving circuit comprises:
a third buffer unit configured to store the second data, and provide the stored second data to the second area of the display panel based on the second clock signal.

15. The display device of claim 14, wherein the first and second display driving circuits drive the display panel after all of the first data is stored in the first buffer unit and all of the second data is stored in the third buffer unit.

16. The display device of claim 12, wherein the second display driving circuit has a structure that is the same as a structure of the first display driving circuit.

17. A display device comprising:
a display comprising a first display panel and a second display panel;
a first display driver that receives a first clock and display data, frequency divides the first clock, without using feedback, to generate a second clock, separates the display data into first data and second data, drives the first display panel using the first data and the second clock, outputs, using the first clock, the second data with a different data frequency than the display data, and outputs the second clock; and
a second display driver that receives the second data and the second clock, and drives the second display panel using the second data and the second clock.

18. The display device of claim 17, wherein the first display driver frequency divides the clock by n to generate the second clock, and n is an integer.

19. The display device of claim 17, where the first display panel and the second display panel are different areas of the display.

20. The display device of claim 17, wherein the display data comprises image data or video data.
